(19) United States
(12) Patent Application Publication
(10) Pub. No.: US 2014/0158239 A1
(43) Pub. Date: Jun. 12, 2014

(54) CONTINUOUS CIRCULATION VALVE

(71) Applicant: M-I L.L.C., Houston, TX (US)

(72) Inventor: Donald G. Reitsma, Vernon (CA)

(73) Assignee: M-I L.L.C., Houston, TX (US)

(21) Appl. No.: 14/100,903

(22) Filed: Dec. 9, 2013

Related U.S. Application Data
(60) Provisional application No. 61/734,642, filed on Dec. 7, 2012.

(51) Int. Cl. F16K 11/02

(52) U.S. Cl. CPC F16K 11/02
USPC 137/625.46

(57) ABSTRACT

A valve comprises a housing and a closing member. The housing provides a flow path and comprises a chamber with a first opening and a second opening. The housing further comprises an upstream port, a downstream port and a lateral port. The closing member is located inside the chamber and is rotatable selectively between a first position and a second position so as to dose the first opening and the second opening respectively The lateral port is in flow communication with the downstream port in the first position of the closing member. The upstream port is in flow communication with the downstream port in the second position of the closing member. The dosing member has an internal profile that adjoins the flow path. The internal profile is shaped such that a cross-sectional area of the flow path is larger through the chamber than the rest of the flow path.

### CROSS-REFERENCE TO RELATED APPLICATIONS

This application claims the benefit of U.S. Provisional Application No. 61/734,642, filed Dec. 7, 2012, the entire disclosure of which is hereby incorporated herein by reference.

### BACKGROUND

A drill bit is disposed at a lower end of a drill string and is used to drill through subsurface formations to create a wellbore. Drilling fluid may be pumped through an interior passage in the drill string and may be discharged through nozzles or courses in the drill bit. Drilling fluid then flows up an annular space between the drill string and the wall of the wellbore. The drilling fluid cools and lubricates the drill bit, lifts drill cuttings out of the wellbore and carries them to the surface, and provides fluid pressure to maintain the mechanical integrity of the wellbore and prevent fluid disposed in the pore spaces of porous formations from entering the wellbore.

During operations in which the drill string is lengthened or shortened, a continuous circulation valve allows the drilling fluid to be continuously supplied to the wellbore without disruption.

### BRIEF DESCRIPTION OF THE DRAWINGS

Embodiments of the continuous circulation valve are described with reference to the following figures. The same numbers are used throughout the figures to reference like features and components:

FIG. 1 is a cross-sectional view of an example embodiment of a continuous circulation valve showing an upstream port, a lateral port and a downstream port;

FIG. 2 is a side view of a chamber of the example valve showing a closing member in a closed position;

FIG. 3 is a side view of the chamber of the example valve showing the closing member in an open position;

FIG. 4 is a top view of the chamber of the example valve showing the closing member in the closed position with the upstream port omitted from view;

FIG. 5 is a top view of the chamber of the example valve showing the closing member in the open position with the upstream port omitted from view; and

FIG. 6 is a schematic view of the example valve used in an example circuit.

### DETAILED DESCRIPTION

Examples will now be described more fully hereinafter with reference to the accompanying drawings in which example embodiments are shown. Aspects may be embodied in many different forms and should not be construed as limited to the embodiments set forth herein.

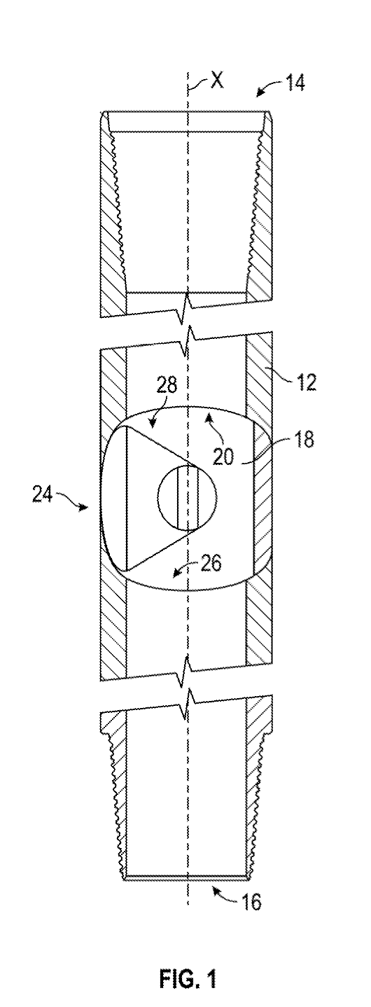

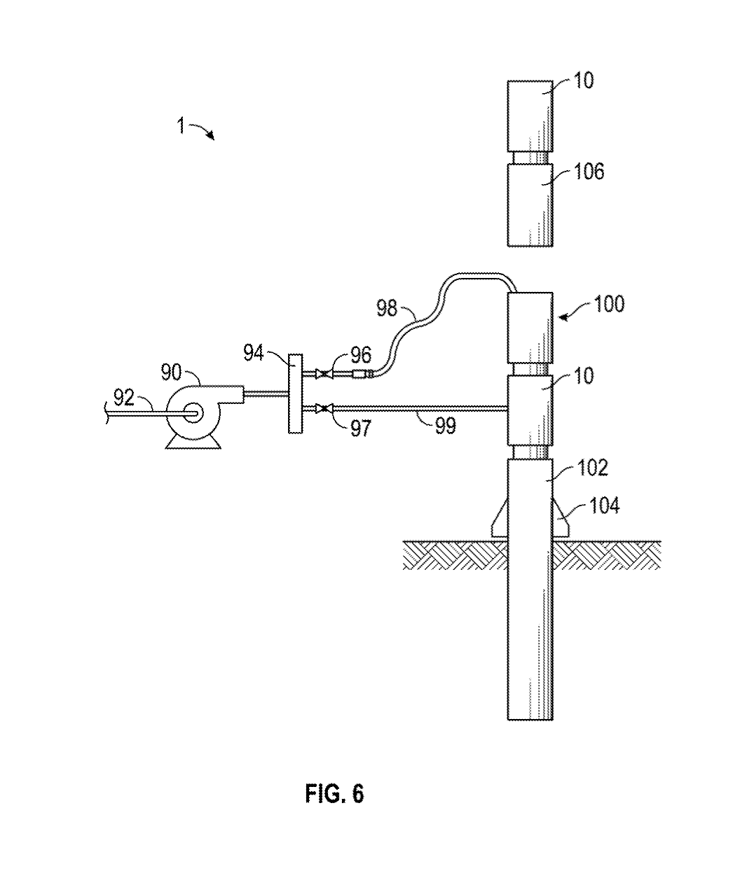

FIG. 1 illustrates an example embodiment of a continuous circulation valve 10 which may be part of a circuit 1 (FIG. 6) that is made up of pipes or tubes and other components through which a fluid may flow or circulate. Thus, the continuous circulation valve 10 may be embodied as a tubular structure in which the fluid may flow.

As shown in the embodiment of FIG. 1, the valve 10 may include an elongate housing 12 defining the tubular structure and may further include features by way of which the flow path of the fluid may be adjusted. The housing 12 may be shaped substantially as a cylinder although other types of geometry (e.g., curved or manifold type) may also be contemplated. Moreover, the cross-sectional area of the cylinder may be a circle, a polygon or the like.

As shown in FIG. 1, the longitudinal ends of the housing 12 may form an upstream port 14 and a downstream port 16 of the valve 10. The upstream port 14 and the downstream port 16 may include threaded configurations to allow the valve 10 to be connected to other components (e.g., tubes) in the circuit 1. In the embodiment of FIG. 1, the upstream port 14 is configured as a female portion of a threaded connection while the downstream port 16 is configured as a male portion of a threaded connection. The cylinder of the housing 12 may have an outer perimeter that is substantially constant from the upstream port 14 to the downstream port 16. However, the outer dimension of the male portion of a threaded connection at the downstream port 16 does not correspond to the outer perimeter of the cylinder of the housing 12 in FIG. 1.

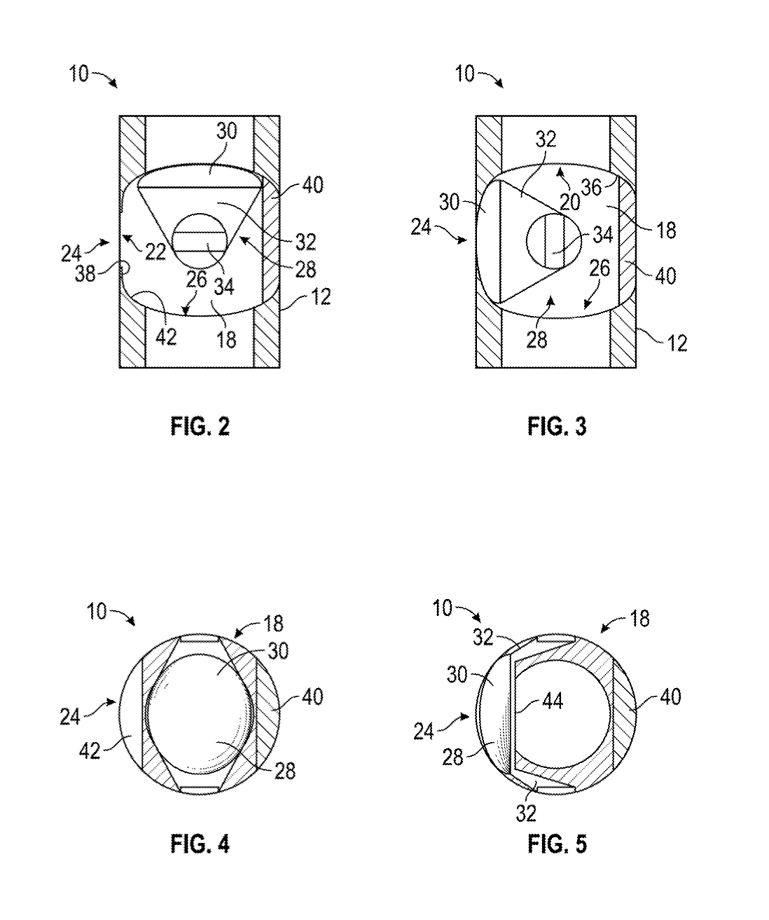

As shown in FIGS. 2-5, the tubular structure of the housing 12 may provide a flow path that extends from the upstream port 14 to the downstream port 16 passing through a chamber 18 in the valve 10. FIGS. 2-3 illustrate side views of the chamber 18 while FIGS. 4-5 illustrate top views of the chamber 18 where the upstream port 14 is omitted from view in FIGS. 4-5 for clarity of illustration of the features inside the chamber 18. FIGS. 2-5 show cross-sectional views of the housing 12 while the closing member 28 is shown in its entirety.

The chamber 18 may include a first opening 20 which may be in flow communication with the upstream port 14. The first opening 20 may be located to intersect with a longitudinal axis X of the housing 12. Moreover, the chamber 18 may also include a second opening 22 and the housing 12 may further include a lateral port 24 that may be in flow communication with the second opening 22. The chamber 18 may also include a third opening 26 through which the fluid exits the chamber 18. The lateral port 24 may be formed on the side surface of the cylinder or tubular structure of the housing 12. The second opening 22 of the chamber 18 may be located radially about the longitudinal axis of the housing 12. Fluid may be supplied to the chamber 18 through either the upstream port 14 or the lateral port 24 and may flow toward the downstream port 16. Thus, the upstream port 14 and the lateral port 24 are upstream of the chamber 18 while the downstream port 16 is downstream of the chamber 18 in terms of fluid flow.

As shown in FIGS. 2-5, the valve 10 may further include the closing member 28 that is located inside the chamber 18. The closing member 28 is rotatable to selectively seal or close the first opening 20 (i.e., a first position or “closed” position of the closing member 28 shown in FIG. 2) or the second opening 22 (i.e., a second position or “open” position of the closing member 28 shown in FIG. 3). The angular displacement of the closing member 28 between the first position and the second position may be about 90 degrees. The closing member 28 may include a sealing portion 30 that is supported by a pair of legs 32 that are pivotably connected to the housing 12. The legs 32 may be symmetrically disposed with respect to the sealing portion 30. The part of the legs 32 that is distal from the sealing portion 30 may be exposed on the exterior of the housing 12 in the form of a keyed portion 34 such that the rotation of the closing member 28 can be controlled by rotating the keyed portion 34. The keyed portion 34 may include a feature such as a notch, a groove, a protrusion or the like that can be engaged to impart a rotating motion on the legs 32 and consequently on closing member 28.

The chamber 18 is dimensioned to provide sufficient space for the closing member 28 to move between the first position and the second position. Moreover, the sealing portion 30 may be convex and the chamber 18 may include curved surfaces to allow the sealing portion 30 of the closing member 18 to move without interference. Specifically, the sealing portion 30 may be convex and have a fixed radius of curvature. Furthermore, the chamber 18 may include a first internal sealing surface 36 and a second internal sealing surface 38, and the first opening 20 and the second opening 22 may be respectively formed thereon. The sealing portion 30 is shaped to correspond to the geometry of the first internal sealing surface 36 such that the first opening 20 and the second opening 22 are appropriately sealed or closed at the first position and the second position. Thus, the first internal sealing surface 36 and the second internal sealing surface 38 may be concave. While the first internal sealing surface 36 and the second internal sealing surface 38 may be shaped identically to one another, the first internal sealing surface 36 and the second internal sealing surface 38 may also vary in shape. Specifically, the first internal sealing surface 36 may be shaped to have a first radius of curvature while the second internal sealing surface 38 may be shaped to have a second radius of curvature. The two radii of curvature may be identical or may differ. Furthermore, the fixed radius of curvature may be smaller than the two radii of curvature and the closing member 28 may be positioned with respect to the first internal sealing surface 36 and the second internal sealing surface 38 such that the sealing portion 30 slightly protrudes into the first opening 20 and the second opening 22.

The terms “concave” or “convex” are intended to encompass shapes that can be described as curved, arcuate, dome-shaped or the like. Moreover, the perimeter around the “concave” or “convex” surfaces may have a variety of shapes such as an oval (FIG. 4), a circle, a square, a rectangle, etc. Furthermore, the “concave” or “convex” surfaces may not have a constant radius of curvature.

In one embodiment, the three-dimensional space defining a chamber 18 may be similar to a cylinder in which the edges of the cylinder may be rounded out and the top and bottom of the chamber 18 may be concave in order to provide a space in which the closing member 28 can move without interference as shown in FIGS. 2-5. Thus, the peripheral regions of the chamber 18 may be rounded out in order to facilitate the movement of the dosing member 28. Moreover, the chamber 18 may provide stoppers to limit the movement of the closing member 28. Specifically, a first stopper 40 may limit the movement of the closing member 28 beyond the first position as shown in FIG. 2 while a second stopper 42 may limit the movement of the closing member 28 beyond the second position as shown in FIG. 3.

As shown in FIG. 5, the sealing portion 30 and the legs 32 of the closing member 28 may be arranged to substantially extend along the peripheral regions of the chamber 18 as the closing member 28 is rotated between the first position and the second position. Such an arrangement may impart an internal profile 44 on the closing member 28 that extends away from the flow path and along the peripheral regions of the chamber 18. For example, the internal profile 44 may adjoin the flow path in a substantially U-shaped fashion. In the embodiment shown in FIG. 5, the internal profile 44 has a trapezoidal shape.

In contrast with the configurations of the chamber 18, the upstream port 14 and the downstream port 16 are simply defined by annular portions of the valve 10. The components of the threaded connections (i.e., male and female portions thereof) may form part of the annular portions but do not correspond to entire annular portions as the male and female portions are intended to accomplish connections between neighboring components. When the neighboring components or tubes are joined together with the valve 10 using the threaded connections to form the circuit 1, the annular portions form a flow path having a constant predetermined cross-sectional area in portions of the valve 10 other than the chamber 18. The predetermined cross-sectional area may be in a circle shape having a given flow path radius. The given flow path radius may be smaller than the fixed radius of curvature of the sealing portion as well as the first and second radii of curvature discussed with regard to the first internal sealing surface and the second internal sealing surface.

The above-discussed configuration of the closing member 28 and the chamber 18, including geometry and dimensions, allow the flow path to move through an increased cross-sectional area in the chamber 18. This is accomplished by providing a chamber 18 with a cross-sectional area larger than the predetermined cross-sectional area at portions of the valve 10 other than the chamber 18. Moreover, the closing member 28 provides reduced interference with fluid flow by arranging the closing member 28 along peripheral regions of the chamber 18. Furthermore, the configuration of the internal profile 44 substantially reduces fatigue failure resulting from repeated rotation of the closing member 28 and pressure induced failure resulting from fluid under pressure being applied to either the longitudinal end of the housing 12 or the downstream port 16.

There may be additional features in the continuous circulation valve that are omitted from FIGS. 1-5. It may be possible for a person of ordinary skill in the art to supplement the above-discussed valve with features known in the art to allow the valve to be operational. For example, U.S. Pat. No. 8,100,199 to Braddick, which is incorporated herein by reference, describes a continuous fluid circulation valve and related features that may be implemented on the valve discussed above.

FIG. 5 illustrates an example circuit or system 1 in which an example embodiment of the continuous circulation valve 10 may be used and shows a well into which a drill string is inserted. It must be noted that the above discussed valve 10 may have applicability outside of the well drilling setting shown in FIG. 5. The valve 10 discussed herein may be used to continuously circulate drilling fluid into the well. Pump 90 pressurizes fluid from supply line 92 which may be connected with the fluid flow out of the well. Pressurized fluid from the pump 90 may be passed through manifold 94, which distributes pressurized fluid through lines 98 and 99 to the continuous circulation valve 10. When valve 97 along the flow 99 is open, pressurized fluid may be supplied to the lateral port 24 of the valve 10. When the valve 96 is open and the valve 10 is adjusted so that fluid can flow through the top of the valve 10, pressurized fluid may be supplied line 98 to a kelly or top drive 100 placed on top of the valve 10 so that fluid will flow through the kelly or top drive 100, through the valve 10, and into the drill string 102, which is supported on slips 104 extends into the well. When the closing member 28 is moving between the first and second positions, fluid may be supplied simultaneously via line 99 to the lateral port 24 in the valve 10 and via the line 98 to the upstream port 14 through the valve 10.

To add a new drill stand to the drill string, all fluid supplied to the valve 10 may be temporarily passed through the line 99, and the valve 96 may be closed to stop the fluid flow to the kelly or top drive 100. A “drill stand” may thus consist of one of more drill joints, and each stand will have its own continuous circulating valve 10 when the stand is added to a drill string With the closing member 28 in the valve 10 in the first position and fluid supplied through the lateral port 24, the kelly or top drive 100 may be unthreaded from the top of valve 10, and another valve 10 placed on top of the next drill stand 106, and a lower end of stand 106 may be threaded to the upstream port 14 of closed valve 10 which is still being supplied with fluid from the line 99. Once this connection of stand 106 to lower valve 10 is made up, lower valve 10 is opened, valve 96 is opened, valve 97 may be closed, and the attachment coupling removed from the lower valve 10, so that fluid may thereafter continuously flow via line 98 to the repositioned kelly 100, through the newly added upper valve 10, through the stand 106, through the lower valve 10, and into the drill string 102. The drill pipe slips may be released, allowing the lower valve 10 and the drill pipe stand to be lowered with the string 102 into the well. Another valve 10 may be positioned at the upper end of the stand 106, and the kelly 100 then placed on top of the new valve 10. The kelly 100 may thus be repeatedly used with each drill stand, while a valve 10 is included for each stand 106.

The term “well drilling” refers to operations wherein a drill bit is positioned at the lower end of a drill string, and is rotated for drilling a portion of the well. As discussed above, well drilling operations may involve rotation of the entire drill string from the surface to rotate the bit, or may involve a slow or no rotation of the drill string at the surface, with high-speed rotation of the bit provided by the positive displacement motor positioned at the lower end of the drill string above the bit. In either event, the valve 10 can be reliably used for continuously supplying fluid to the hit both when lowering a drill string in the well and when connecting or disconnecting a drill joint from the drill string.

In a first example, a valve comprises a housing and a closing member, The housing comprises a chamber with a first opening and a second opening. The housing further comprises an upstream port, a downstream port and a lateral port. The upstream port and the lateral port are upstream of the chamber. The downstream port is downstream of the chamber. The upstream port is in flow communication with the first opening. The lateral port is in flow communication with the second opening. The closing member is located inside the chamber and is rotatable selectively between a first position and a second position so as to close the first opening and the second opening in the first position and the second position respectively. The lateral port is in flow communication with the downstream port in the first position of the closing member. The upstream port is in flow communication with the downstream port in the second position of the closing member. The closing member has an internal profile that adjoins the flow path. The internal profile is shaped such that a cross-sectional area of the flow path is larger through the chamber than the rest of the flow path.

In a second example, a valve comprises a housing and a closing member. The housing comprises a chamber with a first opening and a second opening. The housing further comprises an upstream port, a downstream port and a lateral port. The upstream port and the lateral port are upstream of the chamber. The downstream port is downstream of the chamber. The upstream port is in flow communication with the first opening. The lateral port is in flow communication with the second opening. A closing member is located inside the chamber and is rotatable selectively between a first position and a second position so as to close the first opening and the second opening in the first position and the second position respectively. The lateral port is in flow communication with the downstream port in the first position of the closing member. The upstream port is in flow communication with the downstream port in the second position of the closing member. The chamber is defined by a three-dimensional space. The closing member comprises a pair of leas supporting a sealing portion. The legs and the sealing portion extend substantially along peripheral regions of the three-dimensional space as the closing member is rotated between the first position and the second position.

In a third example, a valve comprises as housing and a closing member. The housing comprises a chamber with a first opening and a second opening. The housing further comprises an upstream port, a downstream port and a lateral port The upstream port and the lateral port are upstream of the chamber. The downstream port is downstream of the chamber. The upstream port is in flow communication with the first opening. The lateral port is in flow communication with the second opening. The housing is dimensioned to provide a flow path with a circular cross-sectional area of a flow path radius. The closing member is located inside the chamber and is rotatable selectively between a first position and a second position so as to close the first opening and the second opening in the first position and the second position respectively. The lateral port is in flow communication with the downstream port in the first position of the closing member. The upstream port is in flow communication with the downstream port in the second position of the closing member. The closing member comprises a sealing portion. The sealing portion is convex and has a fixed radius of curvature. The chamber is defined by a cross-sectional area that is larger than the circular cross-sectional area. The fixed radius of curvature is larger than the flow path radius.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph to for any limitations of any of the claims herein, except for those in which the claim expressly uses the words ‘means for’ together with an associated function.

What is claimed is:

1. A valve comprising:
a housing providing a flow path and comprising a chamber with a first opening and a second opening, the housing further comprising an upstream port, a downstream port and a lateral port, the upstream port and the lateral port being upstream of the chamber, the downstream port being downstream of the chamber, the upstream port being in flow communication with the first opening, the lateral port being in flow communication with the second opening;
a closing member that is located inside the chamber and is rotatable selectively between a first position and a second position so as to close the first opening and the second opening in the first position and the second position respectively, the lateral port being in flow communication with the downstream port in the first position of the closing member, the upstream port being, in flow communication with the downstream port in the second position of the closing member, the closing member having an internal profile that adjoins the flow path, the internal profile being shaped such that a cross-sectional area of the flow path is larger through the chamber than the rest of the flow path.

2. The valve of claim 1, wherein the housing is shaped as a cylinder having an outer perimeter that is substantially constant from the upstream port to the downstream port.

3. The valve of claim 1, wherein the upstream port and the downstream port are defined by a first annular portion and a second annular portion respectively.

4. The valve of claim 3, wherein a cross-sectional area of the flow path in the first annular portion and the second annular portion is a circle with a given radius.

5. The valve of claim 3, wherein a cross-sectional area of the flow path in the first annular portion and the second annular portion has a constant predetermined value.

6. The valve of claim 1, the internal profile being substantially U-shaped.

7. The valve of claim 1, the upstream port comprising a threaded configuration to engage a lower end of a drill joint, the downstream portion comprising a threaded configuration to engage an upper end of a drill string.

8. The valve of claim 1, wherein fluid is to be supplied to the lateral port when the closing member is in the first position, and fluid is to be supplied to the upstream port when the closing member is in the second position.

9. The valve of claim 1, the chamber further including a third opening that is downstream of the upstream port and the lateral port and is upstream of the downstream port.

10. A valve comprising:
a housing providing a flow path and comprising a chamber with a first opening and a second opening, the housing further comprising an upstream port, a downstream port and a lateral port, the upstream port and the lateral port being upstream of the chamber, the downstream port being downstream of the chamber, the upstream port being in flow communication with the first opening, the lateral port being in flow communication with the second opening;
a closing member that is located inside the chamber and is rotatable selectively between a first position and a second position so as to close the first opening and the second opening in the first position and the second position respectively, the lateral port being in flow communication with the downstream port in the first position of the closing member, the upstream port being in flow communication with the downstream port in the second position of the dosing member, the chamber defined by a three-dimensional space, the closing member comprising a pair of legs supporting a sealing portion, the legs and the sealing portion extending substantially along peripheral regions of the three-dimensional space as the closing member is rotated between the first position and the second position.

11. The valve of claim 10, wherein the sealing portion is convex.

12. The valve of claim 10, wherein the closing member is operatively connected to a keyed portion exposed on an exterior of the housing such that the closing member can be rotated through rotation of the keyed portion.

13. The valve of claim 10, the chamber comprising an first internal sealing surface and a second internal sealing surface, the first opening formed on the first internal sealing surface, the second opening formed on the second internal sealing surface.

14. The valve of claim 13, the first internal sealing surface and the second internal sealing surface being concave.

15. A valve comprising:
a housing providing a flow path and comprising a chamber with a first opening and a second opening, the housing further comprising an upstream port, a downstream port and a lateral port, the upstream port and the lateral port being upstream of the chamber, the downstream port being downstream of the chamber, the upstream port being in flow communication with the first opening, the lateral port being in flow communication with the second opening, the housing dimensioned to provide a flow path with a circular cross-sectional area having a given flow path radius;
a closing member that is located inside the chamber and is rotatable selectively between a first position and a second position so as to close the first opening and the second opening in the first position and the second position respectively, the lateral port being in flow communication with the downstream port in the first position of the closing member, the upstream port being in flow communication with the downstream port in the second position of the closing member, the dosing member comprising a sealing portion, the sealing portion being convex and having a fixed radius of curvature, the chamber defined by a cross-sectional area that is larger than the circular cross-sectional area, the fixed radius of curvature being larger than the given flow path radius.

16. The valve of claim 15, the chamber comprising an first internal sealing surface and a second internal sealing surface, the first opening formed on the first internal sealing surface, the second opening formed on the second internal sealing surface.

17. The valve of claim 16, wherein the first internal sealing surface and the second internal sealing surface being concave, the first internal sealing surface having a first radius of curvature and the second internal sealing surface having a second radius of curvature.

18. The valve of claim 17, wherein the fixed radius of curvature is smaller than the first radius of curvature and the second radius of curvature.

19. The valve of claim 15, the first position and the second position differ by about 90 degrees.

20. The valve of claim 15, the chamber including a first stopper to stop the closing member in the first position and a second stopper to stop the closing member in the second position.
